(19) United States
(12) Patent Application Publication
(10) Pub. No.: US 2007/0018981 A1
(43) Pub. Date: Jan. 25, 2007

(54) Electronic display apparatus and display method for the same

(75) Inventors: Zheng Zhang, Shanghai (CN); David Ho, Taipei (TW)

Correspondence Address: BIRCH STEWART KOLASCH & BIRCH, PO BOX 747, FALLS CHURCH, VA, 22040-0747, US

(73) Assignee: Inventec Appliance Corp.

(21) Appl. No.: 11/492,146

(22) Filed: Jul. 25, 2006

(30) Foreign Application Priority Data
Jul. 25, 2005 (TW) 94125178

(51) Int. Cl. G06T 15/20

(52) U.S. Cl. 345/427

(57) ABSTRACT

An electronic display apparatus comprises a lighting unit, a displacement detecting unit, a storage unit and a data processing unit. The lighting unit includes a plurality of light emitting elements aligned in a first direction. The displacement detecting unit is used for detecting displacement data of the electronic display apparatus in a second direction, where the second direction crosses to the first direction and an array area is defined between the first direction and the second direction. The storage unit is used to store a plurality of array image data. The data processing unit is used for receiving the displacement data forwarded from the displacement detecting unit and obtaining one of the array image data from the storage unit, which power of the light emitted by the light emitting elements is controlled according to the displacement data so as to display the array image data on the array area.

### BACKGROUND OF THE INVENTION

(1) Field of the Invention

The invention relates to an electronic display apparatus, and more particularly to the apparatus which utilizes detected displacement data to drive the light emitting elements.

(2) Description of the Prior Art

Visualized broadcasting utilizes various displays as the communication media. In particular, the electronic display apparatus is widely used due to its merits in real-time broadcasting and immediate replaying. Currently, the electronic display apparatuses can be seen in almost all airports, bus stations, banks, metropolis transportation systems and so on. Among these electronic display apparatuses, the display having light emitting diodes in a matrix arrangement is particularly introduced to display literature and pattern visual messages.

In one of the electronic display apparatuses already in the market, a plurality of light emitting diodes are located in a line. Lighting of the diodes is performed in a one-by-one pattern so that movement of the light is perceived. Such an apparatus is widely used in vehicles, electric fans, key packs, pens, and some mobile communication devices.

Referring to FIG. 1, a block diagram is used to shown a conventional electronic display apparatus. The electronic display apparatus 10 includes a storage unit 11, a data-processing unit 12, a direction switch 13 and a lighting unit 14. The lighting unit 14 includes a plurality of light emitting elements (not shown in the figure). The storage unit 11 is used to store array image data. The direction switch 13 is used to detect a moving direction of the electronic display apparatus 10. The data-processing unit 12 can obtain array image data from the storage unit 12 and receive a message of moving direction from the direction switch 13. According to the moving direction, the array image data are shown in a predetermined moving pattern.

Referring to FIG. 2A, FIG. 2B and FIG. 2C, a typical display pattern of the conventional electronic display apparatus is shown in a time order. In FIG. 2A, the electronic display apparatus 10, the electronic display apparatus 10 includes a lighting unit 14 further having 12 light emitting elements 140-149, 14a and 14b. As shown, the electronic display apparatus 10 is embodied as a mobile communication device, and the light emitting elements are located in a line at the back of the device 10.

The lighting unit 14 is shifted from a first position line 101 to a second position line 102 along an A direction 103 as shown. The A direction 103 crosses to the second position line 102, while the first position line 101 is parallel to the second position line 102. By providing the line 101 and the line 102, an array area 105 is defined between the first direction and the second direction. The lighting unit 14 displays array image data in the array area 105 within a unit time. In the case that the unit time is close to the displacement time for the lighting unit 14 shifting from the first position line 101 to the second position line 102, the array image data is shown as the content 15 in FIG. 2A.

Referring to FIG. 2B, when the displacement time for the lighting unit 14 shifting from the first position line 101 to the second position line 102 is almost half of the unit time, the display contents 15a is displaced as shown therein. In FIG. 2B, the character is widened due to a fast movement of the lighting unit 14, and also a complete content of the array image data cannot be shown. Referring now to FIG. 2C, when a frequency of oscillating displacement of said electronic display apparatus 10 is almost twice the unit time, the display contents 15b is shown to be compressed in width due to a slow movement of the lighting unit 14.

Therefore, if the frequency of oscillating displacement of said electronic display apparatus 10 is deviated from the display speed of the array image data, the display content may be widened or compressed so as unable to be recognized. Further, due to a limited palm space to contain the electronic display apparatus 10, the maximum number of the characters to be shown is usually limited to 15 at most, which is definitely unable to display a complete message at a display time. In addition, the current electronic display apparatus 10 can't display continuously a plurality of array image data.

### SUMMARY OF THE INVENTION

Accordingly, it is an object of the present invention to provide an electronic display apparatus, which can utilize detected displacement data to drive light emitting elements, and such that array image data can be shown at a predetermined length-to-width ratio on an array area.

It is another object of the present invention to provide an electronic display apparatus, which can display lengthy array image data in a dynamic display pattern.

It is a further object of the present invention to provide an electronic display apparatus, which can display continuously a plurality of array image data and can dynamically display a pattern listing in a photogene sense.

In the present invention, the electronic display apparatus can include a lighting unit, a displacement detecting unit, a storage unit and a data processing unit. The lighting unit includes a plurality of light emitting elements arranged in a line at a first direction. The displacement detecting unit can detect the displacement of the electronic display apparatus at a second direction. In the present invention, the first direction crosses to the second direction so as to form an array area. The storage unit can store a plurality of array image data. The data processing unit is used to receive displacement data from the displacement detecting unit and to retrieve the array image data from the storage unit. By controlling the illumination of the light emitting elements according to the detected displacement data, the array image data can display in the array area.

The displacement detecting unit includes an acceleration detecting module, a signal processing module and an analog/digital converting module. The acceleration detecting module is used to detect the position and the frequency of oscillating displacement of the electronic display apparatus, and further to output an analog signal. The analog signal is then forwarded to the signal processing module for being amplified to define a voltage signal. The voltage signal is converted into digital displacement data via the analog/digital converting module.

The data processing unit can determine the total displacement and the real-time position by judging the digital displacement data. According to the real-time position of the electronic display apparatus, the data processing unit can control the power of light emitted by the light emitting elements. Thereby, the array image data shown in the array area can have a predetermined length-to-width ratio and thus a widened or compressed image happened to the conventional design can be avoided.

In the present invention, the electronic display apparatus can determine, according to the total displacement data, if or not the array image data extends over the effective region of the array image data. In the case that the array image data contains too many images to be shown at a time on the array area, a dynamic displaying is needed. The dynamic displaying is firstly to locate a region of the array image data, secondly to display the region of the array image data in a unit time, and finally to relocate and display a next region of the array image data. Upon such an arrangement, the complete contents of the array image data can be dynamically, in a shifting way, shown.

Also, the electronic display apparatus of the present invention can display a plurality of array image data. Firstly, a plurality of the array image data are input in order to the electronic display apparatus for orderly displaying. In a predetermined time, predetermined array image data are shown. Then, another array image data next to the predetermined array image data is displayed in the next predetermined time. Upon such an arrangement, the array image data can be displayed continuously. By the photogene, a dynamic show of the array image data can be present.

All these objects are achieved by the electronic display apparatus and the method for the electronic display apparatus described below.

### BRIEF DESCRIPTION OF THE DRAWINGS

The present invention will now be specified with reference to its preferred embodiment illustrated in the drawings, in which:

FIG. 1 is a block diagram showing a conventional electronic display apparatus;

FIG. 2A, FIG. 2B and FIG. 2C show displays of the conventional electronic display apparatus of FIG. 1;

FIG. 3 is a block diagram of a preferred electronic display apparatus in accordance with the present invention;

FIG. 4 is a block diagram of a preferred displacement detecting unit of FIG. 3;

FIG. 5 is a perspective view of an electronic display apparatus of the present invention;

FIG. 6 is a flowchart of a preferred method for the electronic display apparatus in accordance with the present invention;

FIG. 7 shows a typical display of FIG. 5;

FIG. 8 is a flowchart of a preferred dynamic display method for the electronic display apparatus in accordance with the present invention;

FIG. 9 shows a typical display of the electronic display apparatus according to the dynamic display method of FIG. 8;

FIG. 10 is a flowchart of another dynamic figure display method for the electronic display apparatus in accordance with the present invention; and

FIG. 11 shows a typical display of the electronic display apparatus according to the dynamic figure display method of FIG. 10.

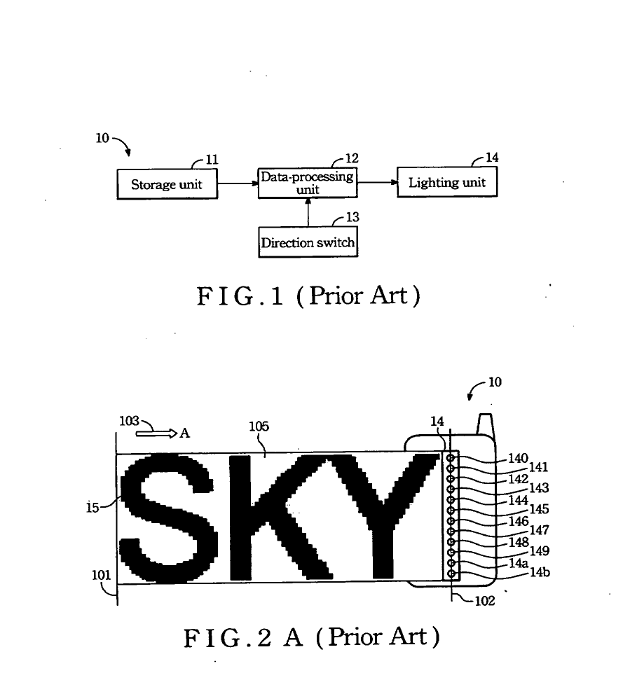

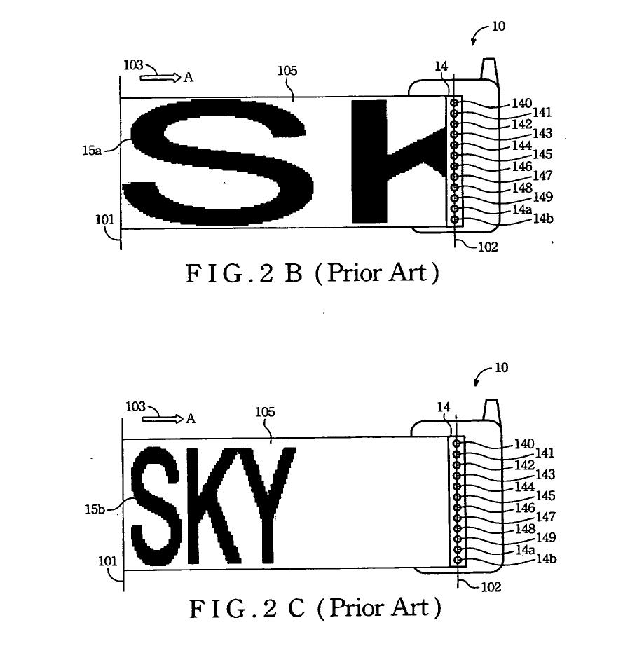

### DESCRIPTION OF THE PREFERRED EMBODIMENT

The invention disclosed herein is directed to an electronic display apparatus and a method for the electronic display apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

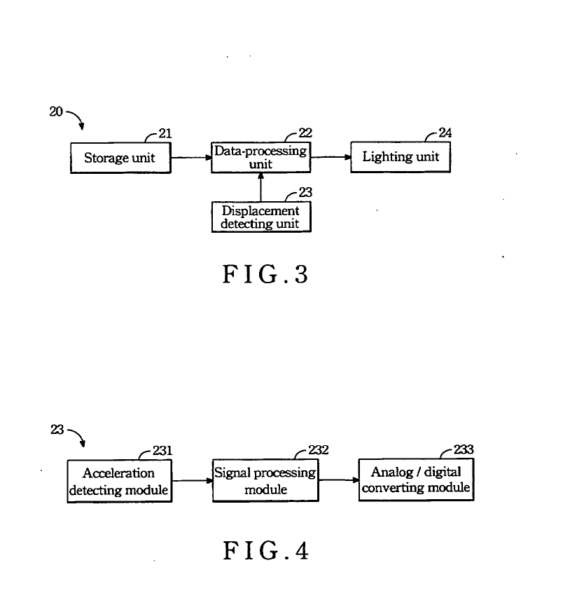

Referring now to FIG. 3, a block diagram of a preferred electronic display apparatus in accordance with the present invention is shown. The electronic display apparatus 20 includes a storage unit 21, a data processing unit 22, a displacement detecting unit 23 and a lighting unit 24. The lighting unit 24 further includes a plurality of light emitting elements aligned in a first direction. The light emitting element can emit monochrome light or multicolored light.

The displacement detecting unit 23 can detect the displacement data of the electronic display apparatus 20 in a second direction. In the present invention, the first direction crosses to the second direction so as to define an array area. The storage unit 21 is used to store a plurality of array image data. The data processing unit 22 is used to receive the displacement data forwarded from displacement detecting unit 23 and to obtain array image data from the storage unit 21. The power of the light emitted by the emitting elements is controlled in accordance with the displacement data, and thereby the array image data can be shown on the array area. In general, the array image data represent the image in a shape selected from a group consisting of letters, characters, symbols and patterns.

Referring now to FIG. 4, a preferred displacement detecting unit 23 of the electronic display apparatus in accordance with the present invention is shown in a block diagram view. The displacement detecting unit 23 includes an acceleration detecting module 231, a signal processing module 232 and an analog/digital converting module 233. The acceleration detecting module 231 is used to detect the position to which said electronic display apparatus is displaced and the frequency of oscillating displacement of said electronic display apparatus 20, and further to output an analog signal. The analog signal is then forwarded to the signal processing module 232 for being amplified to formed a voltage signal. The voltage signal is converted into a digital displacement data via the analog/digital converting module 233. The data processing unit 22 can determine the total displacement and the real-time position of the electronic display apparatus 20 by judging the digital displacement data.

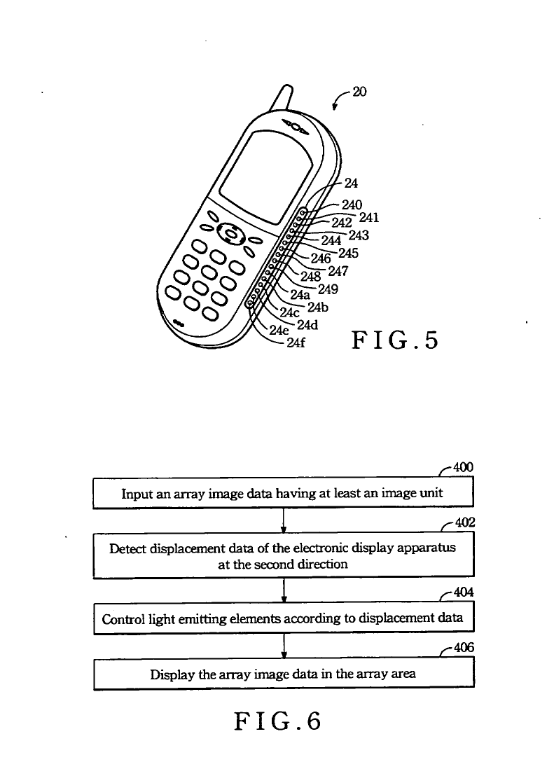

Referring now to FIG. 5, a perspective view of a mobile electronic display apparatus of the present invention is shown. The mobile electronic display apparatus 20 is a mobile communication device. The lighting unit 24 is located at a lateral side of the apparatus 20. The lighting unit 24 further includes 16 light emitting elements 240-249, and 24a-24f lying along a line. In the present invention, the light emitting elements can also be located to other place of the apparatus 20, such as an upper cover, a back plate and so on. Also, the number of the light emitting elements can be determined by the display dimensions.

In the present invention, a display method for the electronic display apparatus in accordance with the present invention is shown in FIG. 6. Firstly, in the electronic display apparatus 20 including a plurality of light emitting elements aligned in a first direction, array image data having at least an image unit (Step 400). Then in Step 402, in the case that the electronic display apparatus 20 is moved, the displacement detecting unit 23 can detect the displacement data of the apparatus 20 in the second direction, in which the second direction crosses to the first direction. In Step 404, the data processing unit 22 controls the power of light emitted by the light emitting element, according to the displacement data. Finally in Step 406, the array image data is shown on the array area.

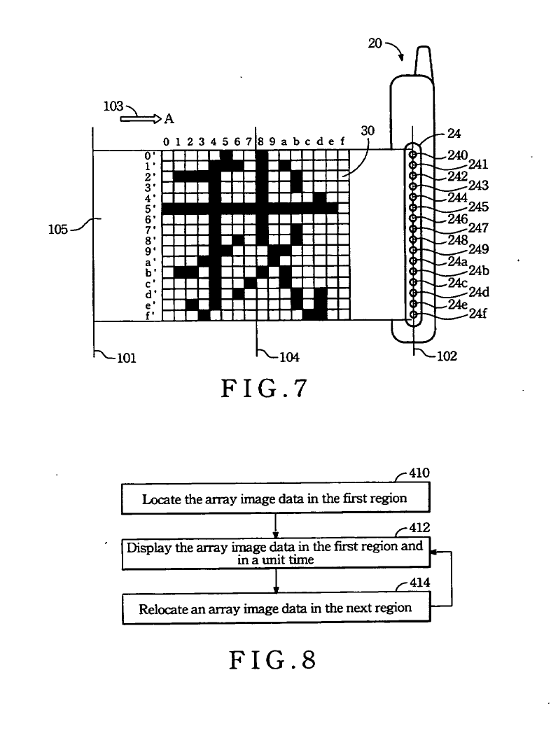

Referring now to FIG. 7, a typical display of FIG. 5 according to the method of FIG. 6 is shown. As shown, in Step 400, an user inputs array image data. Then, the user moves the electronic display apparatus reciprocally along the A direction 103 between the first direction 101 and the second direction 102. The A direction 103 crosses to both the first position 101 and the second direction 102, and thereby an array area 105 is defined between the first direction and the second direction. The data processing unit 22 can receive the displacement data detected by the displacement detecting unit 23 so as to determine the total displacement and the real-time position of the apparatus 20. The total displacement can be the average of the preceding two displacements. As shown in FIG. 7, the central line 104 is the center line to evenly divide the array area 105 into two regions (Step 402). The data processing unit 22 bases on the central line 104 to locate the array image data in the center portion of the array area 105. Further, according to the real-time position, the power of light emitted by the light emitting elements can be controlled. As shown, when the lighting unit 24 hits line d, the data processing unit 22 can drive the light emitting elements 244, 245, 24d, 24e, and 24f to light on. When the lighting unit 24 shifts from line d to line e, the data processing unit 22 can drive only the light emitting element 245 to light on (Step 404). Upon such an arrangement, the array image data 30 can be shown on the array area (Step 405).

Further, in the case that the display of the complete array image data may exceed the display region of the array area, a dynamic displaying in accordance with the present invention is needed. Referring now to FIG. 8, a flowchart of a preferred dynamic display method for the electronic display apparatus in accordance with the present invention is shown. Firstly, according to the total number of the images available on the array area, the array image data of the first region is located (Step 410). Then, in a unit time, the array image data of the first region is displayed (Step 412). Thereafter, the array image data of the next region is relocated (Step 414). Finally, the method is returned to perform Step 412.

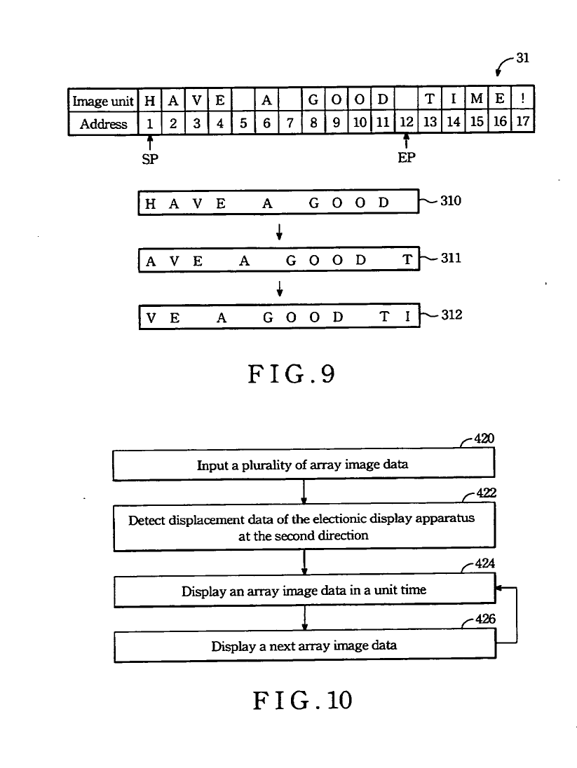

Refer now to FIG. 8 and FIG. 9, in which FIG. 9 is a typical display of the electronic display apparatus according to the dynamic display method of FIG. 8. As shown in FIG. 9, array image data 31 contains 17 images, where the upper row includes the images input by the user and the lower row includes the respective addresses of the corresponding images at the upper row. As shown, column SP is a start flag of a string to be shown, while column EP is an end flag of the string.

Firstly, array image data 31 including 17 images are input. According to the displacement data detected by the displacement detecting unit 24, the array area can only show 12 characters at a time. Thus, column SP is directed to the address 1, while column EP is directed to the address 12 (Step 410). Then, in a unit time, the display content 310 of the electronic display apparatus 20 is the images ranged between column SP and column EP (Step 412). Further, column SP is shifted to the address 2 and column EP is shifted to the address 13 (Step 414). Go back to Step 412. In the next unit time, the display content 310 of the electronic display apparatus 20 is the images ranged between column SP (address 2) and column EP (address 13). As the displaying and the column shifting go on, the images between column SP (address 3) and column EP (address 14) would be shown in the next unit time. Upon such an arrangement, the apparatus 20 can display gradually all the contents of the array image data 31.

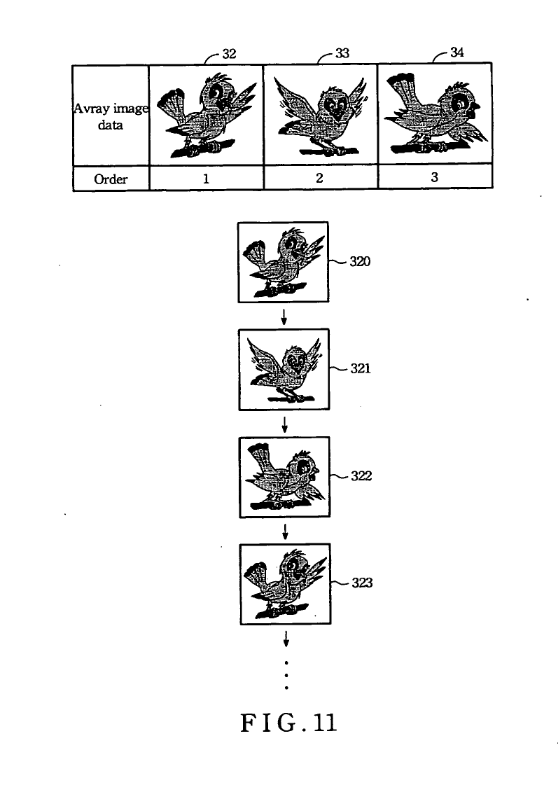

In another aspect of the present invention, a dynamic figure display method for the electronic display apparatus is provided. The flowchart is shown in FIG. 10. Firstly, given that the apparatus 20 has a plurality of light emitting elements aligned in a first direction, the user can input a plurality of array image data in order (Step 420). Then, the user can wave the apparatus 20 for the displacement detecting unit 23 to detect the displacement data of the apparatus 20 in the second direction. The second direction and the first direction are perpendicular so as to define an array area (Step 422). Thereafter, in a unit time, the apparatus 20 can display selected array image data (Step 424). Then, in the next unit time, the next array image data is shown (Step 426). Finally, go back to Step 424.

In step 424, the unit time can be set by the user or can be a constant in the data processing unit 22. Preferably, the unit time for dynamic displaying figures is 0.5-1 second.

Refer now to FIG. 10 and FIG. 11, in which FIG. 11 shows a typical display of the electronic display apparatus according to the dynamic figure display method of FIG. 10. As shown, the array image data of this typical example include three array image data 32, 33 and 34. The lower row of the data includes orders corresponding to the array image data listed in the upper row. The orders defined by the user are the order for displaying the figures (Step 420). Then, the user begins to wave the apparatus 20 for the displacement detecting unit 23 to detect the displacement data (Step 422). Thereafter, in a unit time, the array image data 32 of order 1 is displayed in the array area, as shown in content 320 (Step 424). In the next unit time, the array image data 33 of order 2 is displayed in the array area, as shown in content 321 (Step 424). As the display goes on, the array image data 34 of order 3 would be displayed as content 323 in the next unit time, and, after content 323, the display would go back to content 320. Upon such an arrangement, a dynamic figure displaying can be true to continuously display different figures with discrete motions. By providing the photogene, the dynamic figure displaying can be obtained.

While the present invention has been particularly shown and described with reference to a preferred embodiment, it will be understood by those skilled in the art that various changes in form and detail may be without departing from the spirit and scope of the present invention.

I claim:

1. An electronic display apparatus, comprising:
a lighting unit, including a plurality of light emitting elements aligned in a first direction;
a displacement detecting unit for generating displacement data of the electronic display apparatus displaced in a second direction, wherein the second direction crosses the first direction and an array area is defined between the first direction and the second direction;
a storage unit for storing a plurality of array image data; and
a data processing unit receiving the displacement data forwarded from the displacement detecting unit and obtaining the array image data from the storage unit for controlling power of light emitted by the light emitting elements, according to the displacement data, thereby projecting the array image data on the array area.

2. The electronic display apparatus according to claim 1, wherein said electronic display apparatus is a mobile communication device.

3. The electronic display apparatus according to claim 1, wherein said displacement detecting unit further comprises:
an acceleration detecting module detecting a position to which said electronic display apparatus is displaced, and a frequency of oscillating displacement of said electronic display apparatus, and then outputting an analog signal;
a signal processing module for converting the analog signal forwarded from the acceleration detecting module into a voltage signal; and
an analog/digital converting module converting the voltage signal from the signal processing module into said displacement data.

4. The electronic display apparatus according to claim 1, wherein said light emitting elements comprise a light emitting diode.

5. The electronic display apparatus according to claim 4, wherein said light emitting diode is selected from the group consisting of light emitting diodes emitting monochrome light and light emitting diodes emitting multicolored light.

6. A display method for an electronic display apparatus, the electronic display apparatus comprising a plurality of light emitting elements aligned in a first direction, the method comprising steps of:
a. inputting array image data, representing at least an image, into the electronic display apparatus;
b. generating displacement data of the electronic display apparatus displaced in a second direction, wherein the second direction crosses the first direction and an array area is defined between the first direction and the second direction;
c. controlling power of light emitted by the light emitting elements according to the displacement data; and
d. projecting the array image data on the array area.

7. The display method for an electronic display apparatus according to claim 6, wherein said array image data represent the image in a shape selected from a group consisting of letters, characters, symbols and patterns.

8. The display method for an electronic display apparatus according to claim 6, wherein said electronic display apparatus further comprises a data processing unit and a storage unit, which data processing unit obtains said array image data from the storage unit.

9. The display method for an electronic display apparatus according to claim 6, wherein said electronic display apparatus further comprises a displacement detecting unit and a data processing unit, which displacement detecting unit generates said displacement data and forwards said displacement data to the data processing unit.

10. The display method for an electronic display apparatus according to claim 6, wherein said electronic display apparatus further comprises a data processing unit, which data processing unit judges said displacement data to obtain a total displacement and a real-time position of said electronic display apparatus.

11. The display method for an electronic display apparatus according to claim 10, further comprising the steps of:
a. locating said array image data in a first region;
b. projecting, on the array area, said array image data in the first region in a unit time; and
c. locating said array image data in a next region.

12. The display method for an electronic display apparatus according to claim 11, wherein said electronic display apparatus locates said array image data according to the number of images simultaneously displayable on said array area.

13. The display method for an electronic display apparatus according to claim 11, wherein said unit time is 0.5 second.

14. A dynamic figure display method for an electronic display apparatus, the electronic display apparatus comprising a plurality of light emitting elements aligned in a first direction, the method comprising steps of:
a. inputting a plurality of array image data into the electronic display apparatus;
b. generating displacement data of the electronic display apparatus displaced in a second direction, wherein the second direction crosses the first direction and an array area is defined between the first direction and the second direction;
c. projecting, on the array area, part of the array image data in a unit time by the light emitting elements; and
d. projecting, on the array area, another part of the array image data.

15. The dynamic figure display method for an electronic display apparatus according to claim 14, wherein said array image data are projected in a sequence.

16. The dynamic figure display method for an electronic display apparatus according to claim 14, wherein said electronic display apparatus further comprises a data processing unit and a storage unit, which data processing unit obtains said array image data from the storage unit.

17. The dynamic figure display method for an electronic display apparatus according to claim 14, wherein said electronic display apparatus further comprises a displacement detecting unit and a data processing unit, which displacement detecting unit generates said displacement data and forwards said displacement data to the data processing unit.

18. The dynamic figure display method for an electronic display apparatus according to claim 14, wherein said electronic display apparatus further comprises a data processing unit, which data processing unit judges said displacement data to obtain a total displacement and a real-time position of said electronic display apparatus.

19. The dynamic figure display method for an electronic display apparatus according to claim 14, wherein said unit time is 1 second.
